(19) United States
(12) Patent Application Publication
(10) Pub. No.: US 2015/0170258 A1
(43) Pub. Date: Jun. 18, 2015

(54) Systems and Methods for Displaying the Location of a Product in a Retail Location

(71) Applicant: aisle411, Inc., St. Louis, MO (US)

(72) Inventors: Matthew Kulig, Millstadt, IL (US); Nathan Pettyjohn, St. Louis, MO (US); Ed Saunders, St. Louis, MO (US); Niarcas Jeffrey, Cincinnati, OH (US); Dante Cannarozzi, St. Louis, MO (US)

(21) Appl. No.: 14/632,832

(22) Filed: Feb. 26, 2015

Related U.S. Application Data
(63) Continuation-in-part of application No. 14/575,432, filed on Dec. 18, 2014.
Application No. 14/575,432 is a continuation-in-part of application No. 13/461,738, filed on May 1, 2012.
Application No. 13/461,738 is a continuation-in-part of application No. 12/134,187, filed on Jun. 5, 2008, now abandoned.
(60) Provisional application No. 62/012,882, filed on Jun. 16, 2014.
(60) Provisional application No. 62/017,066, filed on Jun. 25, 2014.

(51) Int. Cl. G06Q 30/06; G06T 11/60

(52) U.S. Cl. CPC G06Q 30/0639; G06T 11/60; G06T 2210/61

(57) ABSTRACT

Systems and methods for providing product search and location searches to a user in a retail location using a personal user device of such user. The systems and methods generate store maps from retail and planogram data, which are downloaded to the user device and the location of products sought by the user is indicated on the map using a location visualization.

### CROSS REFERENCE TO RELATED APPLICATIONS

This application is a Continuation-In-Part of U.S. patent application Ser. No. 14/575,432, filed Dec. 18, 2014, and currently pending, which is, in turn, a Continuation-in-Part of U.S. patent application Ser. No. 13/461,738, filed May 1, 2012, and currently pending, and which is, in turn, a Continuation-In-Part of U.S. patent application Ser. No. 12/134,187, filed on Jun. 5, 2008, now abandoned. This application also claims benefit of U.S. Provisional Patent Application No. 62/012,882, filed Jun. 16, 2014, and also claims benefit of U.S. Provisional Patent Application No. 62/017,066, filed Jun. 25, 2014. The entire disclosures of the above applications are incorporated herein by reference.

### BACKGROUND

1. Field of the Invention

This disclosure is related to the field of indoor mapping and location, specifically to the use of mobile computing devices to display the indoor location of products based upon vendor-supplied product location and merchandizing fixture data.

2. Description of the Related Art

Despite the prevalence of on-line shopping solutions and the ability to conduct extensive product research in advance, the majority of retail purchasing decisions are made by consumers in stores. A major factor influencing the purchasing decision is whether the consumer can easily find the desired product. When a consumer struggles to find a product, the consumer is much more likely to give up (and not purchase it at all) even if the item is available for sale and the consumer desires to purchase it. The consumer may instead try another location, resulting in abandoned carts and lost sales.

Retail locations are generally organized by aisle, with related products stored in close physical proximity to one another. Signs are usually hung over the aisles indicating, in relatively broad categories, the type of products found in the aisle. While this provides consumers with some ability to navigate to the proper aisle, locating a particular product within an aisle may be a chore. This is particularly true where the category of products in the aisle includes a wide variety of different products densely packed together, such as “breakfast cereals” or “wine,” and picking through the many options to find one specific product may be time-consuming and laborious. Further, certain products could fall into several different categories and the categories on the overhead signs may not provide enough information for the consumer to determine which aisle contains a desired product. If the consumer picks the wrong aisle, the consumer may search hopelessly for the product and become frustrated, resulting in lost sales.

Most consumers carry personal mobile devices, and it is desirable to provide users with a mobile device application which can assist the user in locating products in a particular retail venue. However, doing so is difficult. For one, maintaining a product location database on a mobile device consumes large amounts of storage, and synchronizing the database as store inventory and stocking locations change consumes bandwidth, which may be at a premium when the user is in a store and may have limited wireless data bandwidth. Moreover, most users searching for products in a store know generally the category of product sought, but may not necessarily know which specific product they want. Those choices may depend on what specific variants are currently on sale, or the user's tastes at the moment of purchase decision. For example, users generally seek the “yogurt” section but generally do not know in advance which specific flavors of yogurt they plan to purchase. Instead, they peruse the available options once they find the yogurt section. Thus, if the user searches a product database for “yogurt,” dozens and possibly hundreds of results may be returned, when the user simply wishes to know generally where the yogurt is.

For other products, however, the user does wish to buy a specific brand, size, or style. This can be difficult when the product, by its nature, is densely packed on large shelves, requiring the user to walk up and down aisles searching hundreds of products for one specific brand. For example, wine is generally densely stocked, but wine purchasers generally know which wine they want, and finding one particular brand may be time-consuming.

Further, while users eventually learn the layout of a store, it often happens that a person not familiar with the store is doing the shopping. For example, where one spouse typically does the grocery shopping, the other may pick up groceries on the way home from work.

Thus, it is desirable to develop a mobile device based product location search and location service which can provide varying levels of location precision.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein, among other things, is a method for displaying a location visualization to a user comprising: providing a server communicatively coupled to a non-transitory computer-readable server memory, the computer system being communicably coupled to a data network; providing a user device having a user device memory and being communicably coupled to the data network; receiving retailer data for a retail location, the retailer data comprising product data for a plurality of products offered for sale at the retail location; receiving planogram data for a retail location, the planogram data comprising: fixture location data indicative of the relative positions of and dimensions of a plurality of fixtures in the retail location; for each fixture in the plurality of fixtures, an indication of at least one product stocked on the each fixture, the at least one product being a product in the plurality of products in the retailer data; for each fixture in the plurality of fixtures, calculating a map point in the retail location, the calculated map point being determined least in part based upon the relative position of the each fixture in the retail location; for each fixture in the plurality of fixtures: for each product in the at least one product stocked on the fixture, storing in a the non-transitory computer-readable memory a database record comprising search criteria for the each product and a unique identifier for the calculated map point corresponding to the each fixture; generating a map image portraying the position of the at least one fixture in the retail location based at least in part on the fixture location data; for each calculated map point, calculating a pixel location on the map image, the calculated pixel location being a location on the map image corresponding to the location of the each calculated map point in the retail store; the user device receiving over the network the map image and translation data, the translation data comprising, for each calculated map point, the unique identifier and the calculated pixel location on the map image corresponding to the each calculated map point; the server receiving from the user device over the network user search criteria; the server identifying database record(s) having search criteria matching the user search criteria; for each identified database record, the server sending to the user device over the network the unique identifier in the each identified database record; for each unique identifier received by the user device, the user device using the received translation data to translate the received unique identifier to the calculated pixel location for the map point; the user device displaying the map image; the user device displaying on the displayed map image, for each translated pixel location, a location visualization at the pixel location.

In an embodiment, the data network is the Internet.

In an embodiment, the user device is a smart phone or tablet computer.

In an embodiment, the unique identifier is a serial number.

In an embodiment, the search criteria is a text string.

In an embodiment, the search criteria is a product identification code.

In an embodiment, the location visualization is a pindrop.

In an embodiment, retailer data comprises, for each product, product name, product description, or product category.

In an embodiment, planogram data is received from planogramming software.

In an embodiment, each calculated map point is a relative position in the retail location with respect to a predefined origin point.

In an embodiment, the each relative position for the plurality of fixtures is a relative position in the retail location with respect to a predefined origin point.

In an embodiment, the user device determining the location of the user device in the retail location; the user device displaying on the displayed map image an indication of the position of the user device in the indoor location.

In an embodiment, each database record for each product further comprises taxonomical data for the each product.

In an embodiment, for each database record for each product, the search criteria comprises a synonym for the each product, phonetic data for the each product, and/or slang for the each product.

In an embodiment, the location visualization further comprises user interface elements for a user to indicate whether the user found the desired product at the location in the store indicated by the location visualization.

### BRIEF DESCRIPTION OF THE DRAWINGS

FIGS. 1A and 1B depict an embodiment of a fixture and planogram data pertaining thereto.

FIG. 2 depicts an embodiment of a retail location and fixtures, and certain planogram data pertaining thereto.

FIG. 3 depicts a schematic diagram of an embodiment of a system and method for providing in-store product location services to a user via a user device.

FIG. 4 depicts a flow chart of an embodiment of a system and method for providing in-store product location services to a user via a user device.

FIG. 5 depicts a schematic diagram of an embodiment of an augmented product location database.

FIG. 6 depicts a schematic diagram of an embodiment of a map point location and translation system used in a product location system and method.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

Described herein, among other things, are systems and methods for providing product location services to a user while in a store via a personal user device carried by the user. While the systems and methods described herein are generally in reference to an indoor retail location or store, the systems and methods may be used in any indoor location, whether or not retail in nature, as well as in non-indoor retail spaces, such as farmer's markets and flea markets. It will be understood by one of ordinary skill in the art that all of the above contemplated uses are intended by the terms “retail location” and “store” as used herein.

The systems and methods described herein are generally implemented in a client-server architecture, with certain preprocessing conducted to set up the system. This preprocessing generally includes creating store maps and a product location database for handling product searches, and a map point system for translating between the product location data and the store maps. The client is typically implemented as a software application on a user device carried by the consumer while in the retail location. The user device may be, but is not limited to, a smart phone, tablet PC, e-reader device, wearable technology, or any other type of mobile device capable of executing the described functions. Generally speaking, the user device is network-enabled and communicating with the server system over a network.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including but not limited to eyewear, wristwear, pendants, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer-or machine-readable storage medium or memory.

Throughout this disclosure, terms used herein to describe or reference media holding software, including without limitation terms such as “media,” “storage media,” and “memory,” may include or exclude transitory media such as signals and carrier waves.

Throughout this disclosure, the terms “web,” “web site,” “web server,” “web client,” and “web browser” refer generally to computers programmed to communicate over a network using the HyperText Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the terms “fixture” and “merchandizing fixture” generally refer to a structure or location within a retail location on which products are stored, kept, and/or displayed for sale. Fixtures are generally physical structures, such as shelving units, end caps, window displays, display cabinets, point-of-sale displays, and gondolas. Fixtures may be attached to a building or structure, or may be freestanding or mobile. As used herein, the term “fixture” may, in certain contexts, refer to only part of a physical structure. A “fixture” may be an entire shelving unit (i.e., the shelves on both sides), only one side of a shelving unit, or only one section or region of a shelving unit.

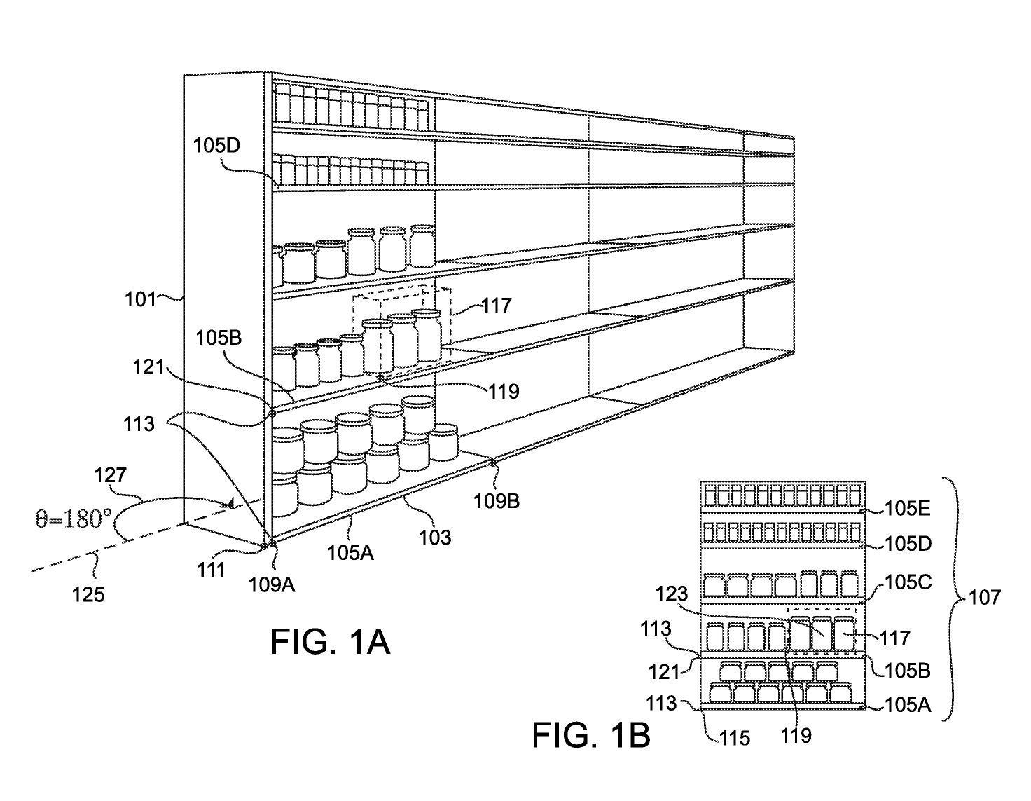

By way of example and not limitation, an aisle fixture in a grocery store generally comprises a plurality of vertical stacks of adjustable-height shelving, each of which is chained together to form the length of the aisle. Each such vertical shelving stack may be considered both a fixture unto itself, and a subfixture of a larger fixture (the aisle). An embodiment of such a fixture (101) is depicted in FIG. 1A, which indicates a fixture (101) comprising three subfixures (103). For sake of clarity and simplicity, the term “fixture” is generally used herein to refer to both an entire shelving unit (101) or one or more subfixtures (103).

It will also be understood by one of ordinary skill in the art that “fixture,” as used herein, may in certain embodiments mean a location where products are stored or displayed for sale, even if a physical structure is not included. By way of example and not limitation, a retail location may, as a marketing tactic, stack cases of soda or beer to form a local sports team logo in advance of a major game featuring that team, which display may not necessarily make use of any physical structures, but rather only the products themselves.

Throughout this disclosure, the term “product” generally refers to goods, services, materials, merchandise, or other tangible or intangible items of value offered by a retailer for sale, rental, lease, or other commercial use by a customer. It will be understood by one of ordinary skill in the art that “product” can refer to a general type or category of products (e.g., “soda”), a particular brand or type of product in such a category (e.g., “Coca-Cola®”), or a particular shipping or distribution configuration of such a product. For example, a two-liter bottle of a particular soda may be a different “product” from a twelve-pack of cans of the same soda, which both may be considered different “products” from twenty-ounce twist-top plastic bottles of the same soda. These may also be the same product, depending on how the term is used in context.

Throughout this disclosure, the term “retailer data” generally refers to data about product inventory at one or more retail locations. For a given product, this data typically includes information such as, but not necessarily limited to: product name; product description; product category; product category tier; product location; multimedia data (e.g., digitized photos, video, branding assets, audio, or other content pertaining to the product); one or more unique product identification codes or identifiers, such as but not limited to, universal product code (“UPC”) and/or stock keeping unit (“SKU”); and, other product attributes. Other product attributes may be any attribute for the product, such as (but not limited to) attributes that are primarily of interest to consumers in making the purchasing decision, such as low-sodium, gluten-free, made-in-America, organic, heart-healthy, union-built, fair trade, and the like. In any given embodiment, for a particular product, there may be one or more of these data for a given product. A product may have a plurality of product descriptions in the retailer data.

Throughout this disclosure, the term “planogram” is a term of art in the retail industry and generally refers to visual representations of the location, organization, layout, or placement of products and/or services offered by a retail location, generally with respect to a specific fixture. A planogram is typically, but not necessarily, a two-dimensional or “flat” diagram or model showing the placement of products on the fixture. While planograms may be implemented using paper and other media, planograms are usually created using planogramming software products. Generally, a planogram pertains to, describes, or is associated with a fixture (101) or subfixture (103), and includes data about the location and dimensions of one or more organizational dividers, such as shelving (105). Accordingly, a given fixture (101) may have a plurality of associated planograms. Planograms are also sometimes also referred to in the art as plano-grams, plan-o-grams, schematics, or POGs.

Throughout this disclosure, “planogram data” generally refers to planning and location data for a retail location, such as but not necessarily limited to fixture (101) location and size, shelf location and size within a fixture, and product stocking location and size within a fixture or shelf. Planogram data for a particular retail location generally comprises data for the plurality of planograms which describe the inventory layout at that retail location. This data is typically organized hierarchically, and is stored, maintained, or organized in planogramming software or other inventory management systems, such as but not necessarily limited to JDA.

One of ordinary skill in the art will appreciate that, in certain embodiments, planogram and retailer data may be intermingled. Thus, while retailer data and planogram data are generally described and used herein to refer to two different sets of data, it will be understood by one of ordinary skill in the art that, in a particular embodiment, retailer data could include some or all of the data described herein as planogram data, and/or planogram data could include some or all of the data described herein as retailer data.

Throughout this disclosure, the term “image” generally refers to a data record or representation of visually perceptible information. It will be understood by one of ordinary skill in the art that this includes, but is not limited to, two-dimensional still images and digital photographs, as well as three-dimensional pictures, holograms, and video.

Throughout this disclosure, specific commercial or branded products may be described or identified as illustrative or exemplary embodiments of particular technologies. By way of example and not limitation, MySQL™ is known in the art to be an implementation of a database. It will be understood by one of ordinary skill in the art that such products inherently or implicitly disclose the broader category of products of which they are representative. By way of example and not limitation, MySQL™ further discloses any database implementation, such as but not limited to, Oracle®, PostgreSQL™, and other database systems, whether or not tabular or SQL-based, such as NoSQL.

The definitions provided herein should not be understood as limiting, but rather as examples of what certain terms used herein may mean to a person having ordinary skill in the applicable art. A person of ordinary skill in the art may interpret these terms as inherently encompassing and disclosing additional and further meaning not expressly set forth herein. It should also be understood that, while certain terms are defined above, the absence of a given term in the above definitions should not be understood to mean that such term is not defined elsewhere herein.

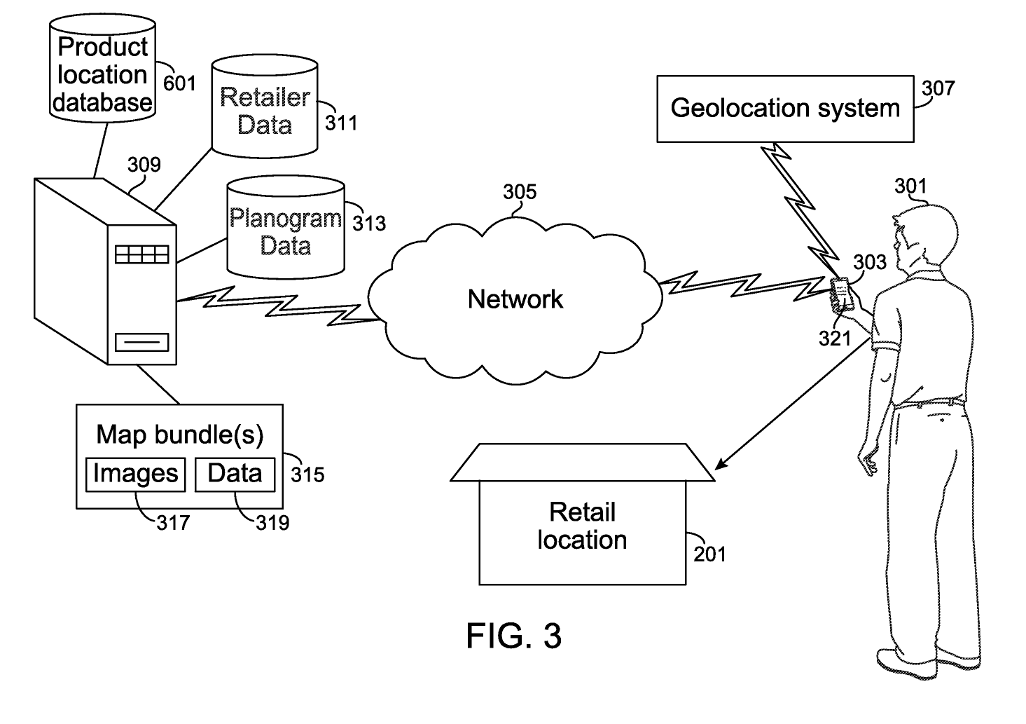

At a very high level, the systems and methods described herein facilitate product location services on a user device (303) while the user is in a retail location. FIG. 3 depicts a general overview of an embodiment of the systems and methods described herein. The depicted embodiment generally comprises accessing/receiving and analyzing/processing retailer data (311) and planogram data (313). The data (311) and (313) is generally processed programmatically/procedurally, manually, or both. This processing generally initializes and populates a product location database (601) communicatively coupled to a server (309). The product location database (601) generally comprises product information from retailer data (311) augmented with taxonomies and grammars, and, for each product, map point identifiers associated with a given location in the store where the product may be stocked. The processing also generally produces a map bundle (315) comprising map images (317) of the retail location, and data (319) for translating map points to pixel locations on the map images (317) to facilitate location visualization on the user device (303). The map images (317) are generally created by analyzing planogram data (313) and performing mathematical operations to detennine the location of fixtures and possibly other features within the store, and generating map images (315) reflecting the relative locations of the identified features. The system may further include application software (321), which may be a standalone application or a web browser accessing a web site, on a user device (303) for downloading and/or displaying the map images (315) and transmitting product search requests from the user (301) to the server (309), and displaying an indication of the returned product location data on the displayed map images. The system generally further includes server (309) software for fielding user search requests. These and other elements and component systems are described in more detail herein.

In the depicted embodiment, a product location database (601) is created or, if such a database (601) already exists, updated. FIGS. 3, 5, and 6 depict embodiments of such a database (601). This database (601), when populated, generally comprises data about the products for sale in the retail location and associated locations of those products in the store. This database (601) is preferably created programmatically, at least in part from retailer data (311) and/or planogram data (313). This is usually done by processing retailer data (311) and planogram data (313) to identify unique products in the data, and creating one or more rows in the product location database (601) for each product identified.

This database (601) is generally used for locating retail products in response to user (301) searches. However, a common problem with retailer data (311) is that products may be identified in industry jargon and shorthand. For example, a twelve-pack of twelve-ounce Coca-Cola® soda cans may be identified in retailer data (311) in shorthand, such as “CK PK 12 0Z.” Thus, a user who provides “coke” or “soda” as a search term will not match this product.

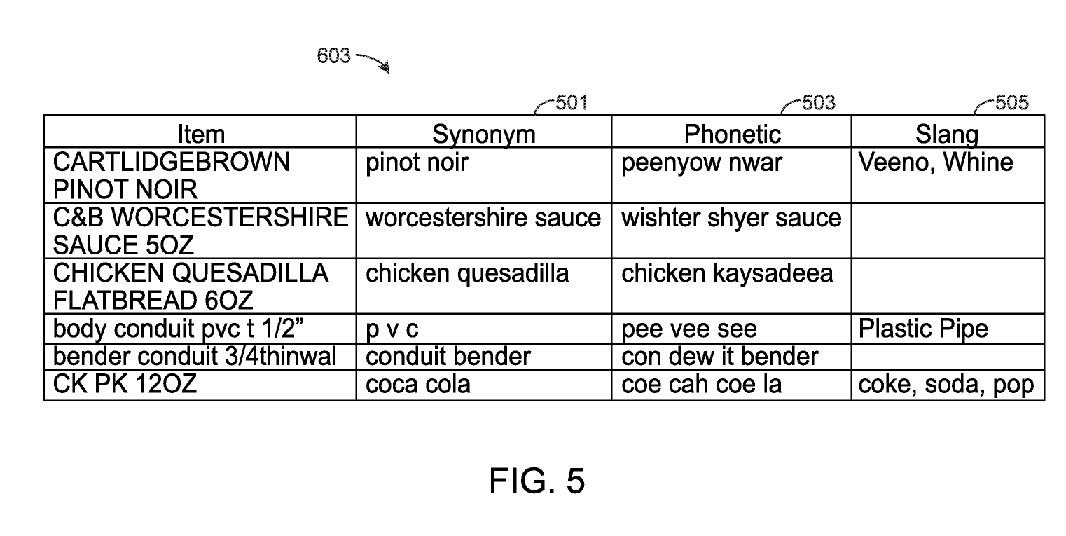

To improve searching and matching, retailer data (311) may be augmented in the databae (601) by taxonomies and grammars, which may include phonetic data, synonyms, and/or slang. An embodiment of such an augmented database (601) is depicted in FIG. 5. In the depicted embodiment, product data for a carbonated beverage is augmented with phonetic data (503) (“coe cah coe la”), a synonym (501) (“coca cola”), and a plurality of slang terms (505) (“coke,” “soda,” “pop). Thus, a search for “coke” or “pop” will match the above product, even though the retailer data (311) contains neither term in association with this product. Similarly, a search for “koka kola” will likely also return this entry due to the phonetic match. Augmenting the database (601) may be done automatically, manually, or both.

Also, the product location database (601) can identitfy products at different levels of detail, precision, or granularity. A user searching for “pop” or “soda” may be assumed to be interested in product location at the aisle level, whereas a user searching for “coke” or “pepsi” may be interested in product location at the brand (sub-aisle) level. Still further, a user searching for “coke 20 oz” may be interested in a very specific packaging configuration. As described in more detail elsewhere herein, products may be organized into, or associated with, one or more category tiers or product taxonomies in the database (601), which may be used to estimate the desired precision level of the server response.

The database (601) is generally created, stored, maintained, and updated in memory, generally but not necessarily a non-volatile computer-readable storage medium. The database (601) is generally communicatively coupled to the server (309). The database (601) may be on storage within the same physical chassis as the location server, or on another server, such as but not limited to a cloud computing platform (not depicted).

Also in connection with processing retailer and/or planogram data, map images are created or generated. Generally, the map images are generated at least in part from planogram data, though map images may also be improved, augmented, or otherwise supplemented by other data sources as well, or manually edited. Generally, the generated map images described herein indicate the overall layout of major store features, such as walls, entranceways, checkout counters, customer service counters, store departments, restrooms, and/or fixtures.

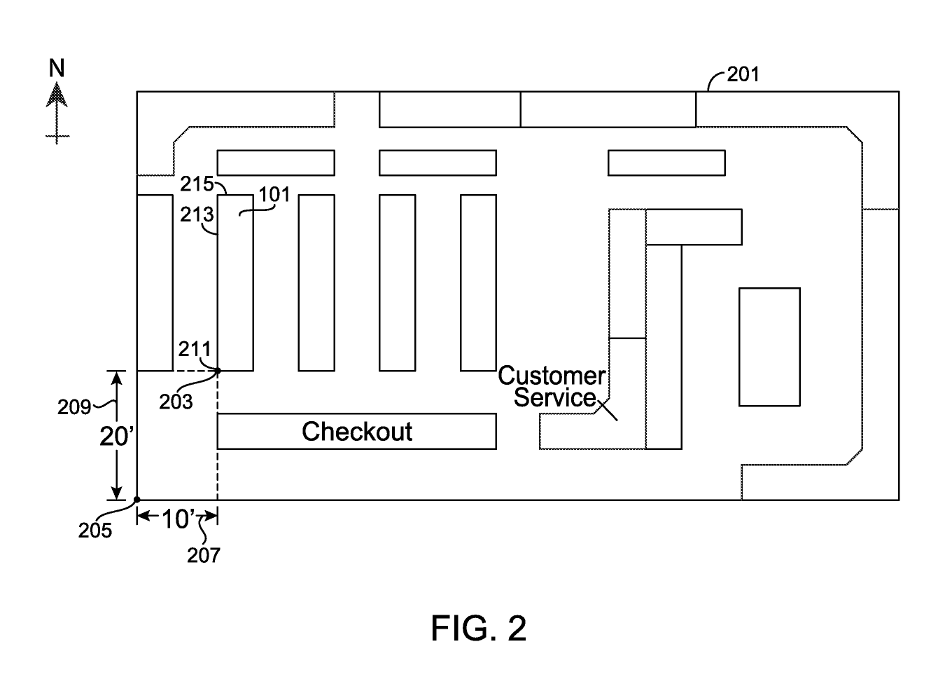

FIGS. 1A, 1B, and 2 depict embodiments of a fixture and store layout, respectively, which may clarify the data and measurements described herein. Fixtures (101) are identified in planogram data (and/or retailer data) by fixture location data. Fixture location data generally comprises a relative location (203) of the fixture (101) in a store (201). This relative location (203) may indicated by, for example, a set of coordinates at which the fixture (101) is located (203) relative to a fixed origin point (205) in the store (201). The coordinates may be two-or three-dimensional. By way of example and not limitation, in the depicted embodiment of FIG. 2, the retail location origin point (205) is the southwest corner of the retail location (201), and the fixture (101) is located ten feet east (207) and twenty feet north (209) of the store origin point (205). Generally, the coordinates indicate the relative location (203) of a predefined point or element of the fixture (101). In the depicted embodiment, the predefined point (211) on the fixture (101) located at these coordinates (207) and (209) is the bottom left corner (211). Thus, fixture location data for this fixture (101) indicates that the fixture (101) has relative location (203) coordinates (207) and (209) of {10′, 20′}.

Fixture location data may further comprise the dimensions (213) and (215) of the fixture (101). Although only two dimensions are depicted, three dimensions may be provided in fixture location data. The combination of the relative location (203) of the fixture (101) and its dimensions (213) and (215) is generally sufficient to generate a map image (317) indicating the location and size of the fixture (101) with respect to the retail location (201). In some embodiments, map images (317) may be generated without other data, though other data is generally used to facilitate the product location systems and methods described herein. For a given retail location (201), there generally will be a plurality of fixtures (101), and thus a plurality of fixture location data sets in the planogram data (313).

Similarly, in the typical embodiment, for each fixture (101), planogramming software creates one or more planograms. In the depicted embodiment of FIG. 1B, a planogram (107) is created for a subfixture (103). The scope and extent of a subfixture described by a given planogram may vary from retail location to retail location, and may vary from aisle to aisle within a retail location, as described elsewhere herein. For a given fixture (101), there may be one or more planograms (107) created. The relative location (109A) on the fixture (101) described by the planogram (107) is also indicated in planogram data (313). The relative locations (109A-B) are each a position relative to an origin point (111) on the fixture (101). This origin point (111) may be the same element of the fixture (101) as the point (211) used to determine the location of the fixture in the store (111), or may be a different point.

Planograms (107) are generally ordered for a given fixture (101) (e.g., there is a first, second, third, etc., planogram for Fixture A, and a first, second, third, etc., planogram for Fixture B, and so forth). The origin point (111) for the fixture (101) for purposes of planogram relative locations (109A-B) is generally a known, pre-defined, or understood origin point (111). By way of example and not limitation, the first planogram (107) for the depicted fixture of FIGS. 1A and 1B may have an associated relative location (109A) of two inches in from the bottom left corner (111) of the fixture (101) (as determined when facing the fixture). A second planogram (not depicted) for the fixture (101) may have an associated relative location (109B) of five feet and two inches from the bottom left corner (111) of the fixture (101). The planogram data (313) may further comprise the dimensions of the planogram, which are generally the dimensions of the subfixture (103) which the planogram (107) describes. Mathematical calculations may be performed to determine where in a retail location (201) the subfixture (103) or planogram (107) is located. Although individual subfixtures and planograms are generally not depicted on generated map images (317), the data described above is sufficient to do so and it is specifically contemplated that they could be.

For each planogram, planogram data (313) generally further comprises shelf location data. It is common that shelf (105) placement in a fixture (101) and (103) is adjustable, to accommodate the specific types of products to be stocked, and shelf (105) placement for a given fixture (101) and (103) may differ substantially from another, even if the fixtures are physically near each other in the store (201) (e.g., adjacent subfixtures (103) in an aisle). Shelf (105) location data is generally a relative location (113) of each shelf (105) described in a planogram (107) with respect to an origin point (115) in the planogram (107).

By way of example and not limitation, in the depicted embodiment of FIGS. 1A and 1B, the planogram (107) depicts five shelves (105A-E) in a subfixture (103), the first shelf (105A) being at the origin point (115) and having shelf (105) location coordinates of {0, 0, 0 }. The second depicted shelf (105B) may be, for example, two feet above the first shelf (105A), and thus have a shelf location of {0, 0, 2′}. Each shelf location data set may further comprise the dimensions of the shelf (105), such as the width, depth, and available stocking region height (i.e., the amount of vertical distance above the shelf available for storing products). Again, it should be noted that relative shelf positions and dimensions, like all other measures described herein, could be given in two or three dimensions, and not all dimensions provided are necessarily used in a given embodiment. Mathematical calculations may be performed to determine where in a retail location (201) a given shelf (105) is located. Although individual shelves are generally not depicted on generated map images (317), the data described above is sufficient to do so and it is specifically contemplated that they could be.

Generally, planogram data (313) further comprises stocking region data about one or more stocking regions for a shelf. A stocking region is generally the physical space in a subsection of a shelf allocated for stocking a particular product (123). In the depicted embodiment of FIGS. 1A and 1B, stocking region data generally comprises a relative location (119) of the stocking region (117) with respect to an origin point (121) on the shelf (105B). Each stocking region data set may further comprise the dimensions of the stocking region, such as the width, height, and original point By way of example and not limitation, where the products are jars (123), each having a diameter of four inches and a height of five inches, and the jars (123) are stocked three-across and one-high, the products have a stocking region (117) about twelve inches wide and about five inches tall. The stocking region (117) size may be larger than the products to allow for spacing and padding. Stocking regions may also have additional dimensions, such as depth into the shelving unit, but generally speaking this dimension is not used because products (123) are typically stocked in rows extending to the back of the shelf (105B). Stocking region data may also comprise an indication of the specific product to be stocked in the stocking region. This indication may be an index into other data, such as a unique index into retailer data (311). Mathematical calculations may be performed to determine where in a retail location (201) a given stocking region (117) is located. Although individual stocking regions (117) are generally not depicted on generated map images (317), the data described above is sufficient to do so and it is specifically contemplated that they could be. The location of the stocking region in the store is generally considered the location in the store of the product stocked in the stocking region.

While generally planogram data (313) indicates the location of fixtures, subfixtures, planograms, shelves, and stocking regions using relative offsets with respect to an origin point in the hierarchy described herein, in certain alternative embodiments, coordinates or locations may be relative to other units of organization. By way of example and not limitation, in an embodiment, stocking regions could be provided with respect to the store, as opposed to the shelf on which the stocking region is located. In a further embodiment, a location could be provided in absolute coordinates according to a general location system, such as GPS coordinates, rather than a relative offset in a hierarchy. In a still further embodiment, dimensions could be replaced by coordinates for an opposing corner of a fixture, planogram, shelf, or product stocking region, in which case the dimensions can be calculated.

The planogram data (313) described above (i.e., fixture, subfixture, planogram, shelf, stocking region) may optionally include a rotation angle. This is common for fixtures, but may be possible for any of the location data described. For example, aisles are generally assumed or defaulted to be oriented lengthwise from the front to the back of a retail location. However, certain fixtures, such as endcaps, are oriented at a right angle. For such fixtures, planogram data (313) for the fixture may further comprise orientation data indicating the angle of rotation (127) for the fixture (101) with respect to an origin plane or axis (125). Similarly, the planogram data (313) may assume that all fixtures, even if oriented lengthwise with respect to the store, are by default oriented in a particular fashion. By way of example and not limitation, in the depicted embodiment of FIG. 1A, the system may assume that shelves open to the left as one faces the back of the store. Thus, to the extent that a fixture (101) has shelves open to the right, a rotation angle of 180 degrees (127) may be indicated in the planogram data (313) for that fixture (101). Typically, orientations are 90 degrees, 180 degrees, or 270 degrees, but other orientations are possible. Rotation angles may also be applied to movable or temporary displays, which are more likely to be oriented at unusual angles.

As described above, planogram data (313) is used to generate map images (317) for the retail location. While the detail level of the generated map images (317) is generally not more granular than the fixture or subfixture level, the data above is sufficient to depict more granular detail in the map images (317), up to and including the stocking region level of detail. While this may be used in certain embodiments and use cases, such as administrative tools like a manual map editor, in the typical embodiment, additional detail results in a visually unappealing, cluttered map, particularly when viewed on the relatively small displays of handheld user devices.

The map images (317) are generally generated by creating raster images or other digitize images. This may be done by, for example, populating a pixel matrix in memory based upon the calculated position of the retail location's (201) major features and fixtures (101), and storing the matrix in a standard-compliant image format. Other techniques for generating map images (317) are known to those having ordinary skill in the art. Since the maps are generally used in consumer-grade applications, and are generally downloaded over wireless data networks, the format is preferably a lossless compressed format such as, but not necessarily limited to, the Portable Network Graphics (PNG) format. In an alternative embodiment, the map images (317) may be generated as vector graphics.

The map images (317) are generally organized into a plurality of tiled image sets, wherein each one of the tiled image sets represents a complete map of the retail location (201) and its features and fixtures (101) at a particular view magnification level, or “zoom” level. In essence, this means each tiled image set is indicative of the same overall data (i.e., store layout with fixtures), but at differing map image resolutions. This technique is used to overcome the inherent limitations of raster images, which pixelate when scaled and thus give the appearance of quality degradation. When a user (301) viewing the images increases magnification beyond a certain threshold (i.e., the point at which pixilation is apparent), a different set of tiled images is displayed having a higher resolution, allowing the images to be magnified further. All of these sets of tiled map images for a given store are generally included within the map bundle (315) for the store.

As indicated, in an alternative embodiment in which vector graphics are used, the need for a plurality of tiled sets may be eliminated or reduced, as vector graphics can generally be scaled arbitrarily without an apparent loss of quality, subject to the limitations of the display hardware on which they are viewed.

In addition to map images (317), drawing instructions for procedurally generating one or more store maps may also be generated. Such instructions generally comprise a plurality of polygon and/or line or vector definitions indicating the size, shape, placement, dimensions, and aesthetic attributes (e.g., color, borders, shading, gradients, shadows, etc.) of polygons and lines which appear on the map. This data may be stored in any format, but in the preferred embodiment, is encoded in a standardized markup language such as Extensible Markup Language (“XML”). Such data is generally included in a map bundle (315) for a particular store. In an embodiment, such drawing instructions are encoded as Scalable Vector Graphics (“SVG”).

The map images (317) and drawing instructions are generally packaged into a downloadable compressed archive referred to as a map bundle (315). Generally, one such bundle is created for each retail location. As described elsewhere herein, the map bundle (315) will generally further comprise data for translating a map point to a pixel location on a map image.

One of ordinary skill in the art will appreciate that some margin of error should be anticipated at each level (i.e., fixture, planogram, shelf, stocking region) because the actual location of fixtures, shelves, and stocking regions will usually vary at least slightly from that indicated in the data. As errors compound, the calculated product location will generally differ from the actual location. While it is often the case that the margin of error is a matter of inches, nearly undetectable by the user, larger margins are of course possible. This disclosure is no way depends upon or requires data to be completely accurate.

In typical (but not all) cases, even significant margins of error are not necessarily problematic because the typical (but not universal) use case is that the user does not seek the exact location of a specific product, but rather the general location of a particular category of products. There are several reasons for this. First, when users prepare a shopping list or think of products they need, they typically do not determine a specific product or packaging configuration until they have already found the general category of products they seek. By way of example and not limitation, when a user wishes to buy Greek yogurt, the user typically goes to the general area of the store where the user believes yogurt is stocked, and does not begin to search for a particular brand or size until the user has reached that location and can browse the available options.

Accordingly, when users use the search feature (described in more detail elsewhere herein) to find products, users will typically provide relatively broad search terms. These terms may match a large number of “products” in the database (601), many of which are packaging variations on a specific brand, and most of which are stocked in the same general area of the store. If location visualizations are displayed for every individually matching product, the screen of the user device (303) could be overwhelmed with visualizations, obscuring the map and degrading the usefulness of the system. Continuing the above example, a search for “yogurt” could yield hundreds of different “products,” each one being a different brand, flavor, size, or type of yogurt, all of which are tightly stocked in a relatively small area. If each matching yogurt product were individually given a location visualization, the cold food section of the displayed map would be cluttered with visualizations, which may be confusing or frustrating to the user. Among other things, map points reduce redundant data and provide a clean, simple interface which provides the user with product location at the desired level of precision.

In the preferred embodiment, each map point is identified by a scalar numeric identifier, which is unique for at least a particular store, but a map point may be any type of identifier which can be uniquely indexed. Map points are typically determined by calculating the midpoint of the physical region in the store to which they apply. Also, the corresponding location of that midpoint on the generated map images (317) is calculated, and translation data is calculated for inclusion in the map bundle (315) for the store. This allows the unique identifier for the map point to be translated to the calculated corresponding locations on the generated map images (317). Alternatively, they may be selected using a particular representative map point, such as a location associated with a particular representative product or a “best match” of available products.

For products stocked in the physical region of the store associated with the map point, the product location database (601) entries for those products include an indication of the unique identifier for the corresponding map point. For example, where a given map point corresponds to a subfixture as defined by a specific planogram, all products indicated in the planogram data (313) as being stocked on the subfixture described by the planogram will generally have their rows in the product location database (601) updated or modified to reference the map point for that subfixture. This allows a search for any of those products to return the same map point identifier, thereby guiding the user to the general area where the products are sought.

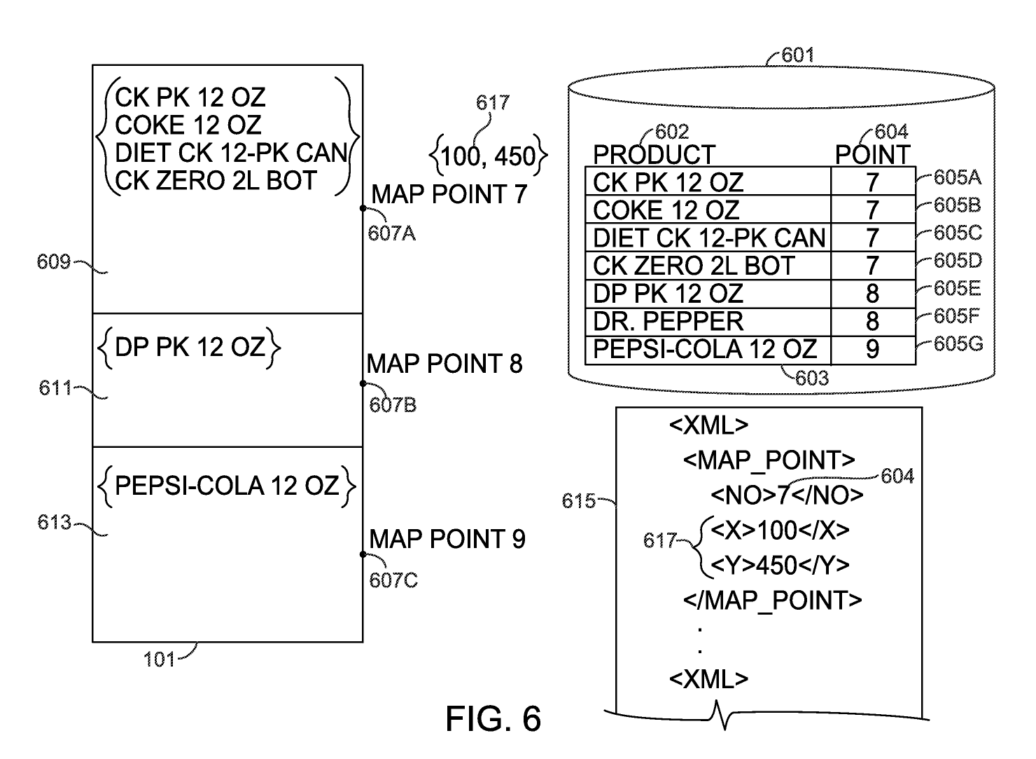

FIG. 6 depicts a schematic diagram of an illustrative example of the use of map points. The server system (309) generally is communicably coupled to the product location database (601). The depicted database (601) comprises a table (603) or other data structure which contains, among other things, product-to-map point associations. In the depicted embodiment, seven entries (605A-G) are present and each table (603) entry (605A-G) has at least two data components: a product identifier (602) and a map point identifier (604). The depicted map point identifiers (604) are positive integers, but other types of identifiers are possible. For sake of simplicity, the product identifier (602) is depicted only in retailer data (311) format, but as described elsewhere herein, this data is generally augmented with phonetics, slang, synonyms, and taxonomical data to improve product lookup accuracy and otherwise improve the usefulness of raw retailer data (311), such as depicted in FIG. 5.

The first four depicted table (603) rows (605A-D) are for Coca-Cola® products and each is associated in the table (603) with map point identifier (604) seven. The next two depicted entries (605E-F) are for Dr. Pepper® products, and are associated in the table (603) with map point identifier (604) eight. The last depicted entry (605G) is for a Pepsi® product, and is associated in the table (603) with map point identifier (604) nine. Each of the map point identifiers (604) corresponds to a physical location (607A-C) in the retail location (201). For example, in the depicted embodiment, map point identifier (604) seven corresponds to a point (607A) generally at the middle of a specific subfixture (103, 609).

The location of map point (607A-C) may be manually determined, but can also be programmatically calculated from planogram data (313). By way of example and not limitation, because the starting point and width of the subfixture (103) can be determined from the planogram data (313), a midpoint can be calculated by dividing the width in half and adding the quotient to the y-coordinate for the starting point of the subfixture (103). This midpoint can then be used as the map point (607A) for the subfixture (103). Using a midpoint is desirable because the map point ultimately is used to determine where on the map images (317) a location visualization will be displayed, and that point is where users are likely to visit. The use of a midpoint centers the user on the subfixture.

As the system processes planogram data (313) and identifies products which have stocking regions in the planogram associated with the map point, those products (602) are stored as rows (605A-G) in the table (603) and their associated map points identifiers (604) are set to the corresponding map point (607A) number (in this illustrative explanation, seven). Alternatively, if rows already exist for the products, the rows are updated with the corresponding map point identifier (604).

When the system processes the next planogram for the next subfixture (103, 611), the system repeats the process, selecting a new unique map point identifier and calculating the location of the map point (607B) using the same technique described above. In the depicted embodiment, the map point identifier (604) for the new map point (607B) is simply incremented (to eight) and products in the planogram for that subfixture (103, 611) are stored in the table (603) and associated with map point identifier (604) eight. This process continues in like fashion through the planogram data (313) for other subfixtures (613) until all map points have been calculated and the applicable products (602) for each have been associated in the table (603) with the corresponding map point identifiers (604).

Once the location of a map point (607A-C) is known, the corresponding location of each map point (607A-C) on map images (317) can likewise be determined. Again, this may be done manually but is preferably done programmatically using mathematical techniques known in the art, including but not limited to basic ratio conversion techniques such as cross-multiplication. The system can then generate translation data to programmatically translate a map point identifier (604) into a pixel location (617) on a map image. By way of example and not limitation, XML data (615) may be generated which identifies the map point (607A) by its unique identifier (604), and provides the X-and Y-coordinates (617) for that map point (607A) on a particular map image. In the depicted embodiment of FIG. 6, for example, map point seven (607A) is calculated as corresponding to the pixel located at {100, 450} on a particular map image, and thus the system generates XML data (615) indicating that the X-coordinate (617) for map point seven (607A) is 100, and the Y-coordinate (617) for map point seven is 450, for the particular map image. As described elsewhere herein, this translation data (615) is packaged into the map bundle (315) for the retail location, along with the map images (317).

Using this arrangement, updating the system when products move is simpler. For example, if the locations of the Coke® and Pepsi® products in this particular store are swapped (e.g., due to changes in distribution), the map point identifiers (604) need only be swapped, but other data pertaining to the products remains the same. That is, if Pepsi® is moved to map point seven (607A), then searches for Pepsi® products will cause the server (309) to return map point identifier (604). Since the user device (303) already has data indicative of the pixel coordinates (617) for that map point (607A), there is no need to download a new map bundle (315).

Similarly, map points address the problem of broad search criteria returning multiple hits which, if all displayed, would clutter the screen. For example, using the systems described herein, any search for a Coke® product will match potentially dozens of different Coke® products in various packaging configurations, but since most of the products are stocked in the same general area of a typical store, most of the products will map in the database (601) to the same map point identifier. Thus, regardless of how the user indicates his or her desire to search for Coke® products, the server will respond with the same map point and the user device (303) will display the location visualization in the same place on the map image. This improves searching and reduces redundancy and screen clutter. This also addresses the problem of filling or sending to the user device (303) large amounts of product location data, most of which is redundant, as it indicates same general area of the store. It should be recognized that in some cases, products may be in disparate location (e.g., endpoints for promotions or sales). In such cases, both could be provided.

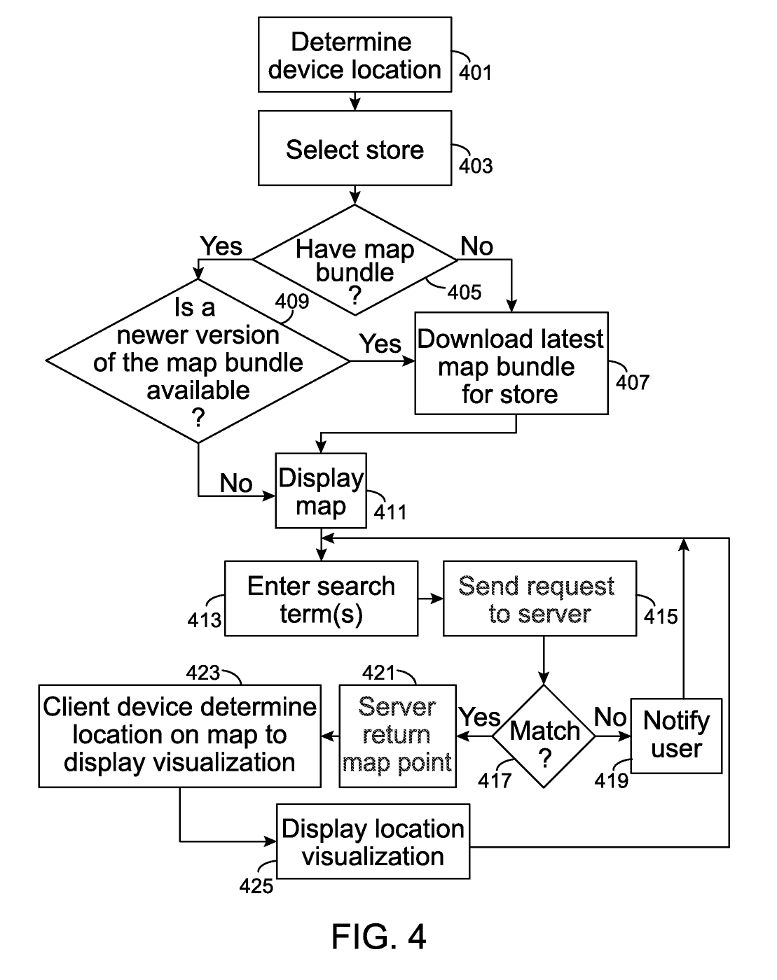

Once the product location database (601) is populated and map bundles (315) are prepared, the system can field product search requests from users. An embodiment is depicted in FIGS. 3 and 4. Product location searches and other user interactions with the server (309) system are generally carried out indirectly using end-user client software (321). The software application is generally stored in the memory systems of the user device (303) and loaded and executed by a microprocessor on the user device (303), as is known in the art. The software application may be a special-purpose application specifically designed for this purpose, such as but not necessarily limited to the aisle411® product location application, or may be an application or service delivered through an alternative or more general-purpose framework, such as a web browser.

Generally speaking, a user (301) having a user device (303) enters a retail location (201) to use the application (321). Usually the user device (303) is a personal device (303) brought by the user into the retail location (201). The user device (303) is generally communicating over a data network (305), such as the Internet. The user device (303) typically includes geolocation technologies, such as a GPS receiver, which can use a geolocation system (307) to determine the approximate location of the device (303) on the Earth. This location is then transmitted to a server system, which may be the same server (309) system used for product location services, or a different server system, over a telecommunications network (305). The server then identifies and/or determines nearby stores for which map bundles (315) are available and transmits to the user device (303) an indication of such stores. The user device (303) then displays a visualization of the received store list to the user. By way of example and not limitation, the user device (303) may display an outdoor map of the area in the vicinity of the detected user device (303) location and indicate on the displayed outdoor map stores for which the server system (309) has map bundles (315). The user may then select the store (403) for which the user desires to use the product location services.

Next, it is determined whether the user device (303) already has (405) a map bundle (315) for the selected store (102) and if so, whether the map bundle (315) on the user device (303) is current (409). If so, bandwidth and battery life can be saved by not re-downloading the map bundle (315) again. If the map bundle (315) for the store (102) has not already been downloaded, or is not up to date, the server system (307) transmits or causes to be transmitted (407) to the user device (303) the map bundle (315) for the store (201) identified by the user. The map bundle (315) is stored in local memory on the user device (303).

Techniques for determining whether updated maps should be downloaded are known in the art. By way of example and not limitation, the last modified date, file size, and/or a digest or other file signature related to the version of the map bundle (315) already stored on the user device (303) may be determined and transmitted to the server. The server may then determine the same data with respect to the version of the map bundle (315) indicated as current in the server (309). If the data does not match, or otherwise is indicative that the server version of the map bundle (315) is newer, the server system transmits the newer map bundle (315) to the user device (303).

The user device (303) displays (411) one of the downloaded map image sets on a display of the user device (303). The displayed image set is generally selected automatically based upon a default magnification level setting.

In addition to map images (317), the software application generally presents graphical user interface elements for manipulating the interface. One such element is an input element for the user to provide search criteria (413) indicative of a product the user wishes to locate in the store. The input element may be a text input element, such as a text box, in which case the user may type the terms or speak the terms using an automatic voice recognition text-to-speech system. In an alternative embodiment, the input element may be an audible input element. In a still further embodiment, the input element may be a visual input element, such as a photo capture or image capture element. In a still further embodiment, the search criteria may comprise a product identification code, such as a UPC or SKU. The search criteria provided by the user are transmitted to the server (415) over the network (305).

The server (309) receives and processes the search criteria, and attempts to locate a matching (417) product (or plurality of products) in the database (601). As described above, products in the database are generally associated with a map point identifier (604). If any matches are found (417), the server prepares a datagram comprising an indication of the corresponding map point identifier (or a plurality thereof, as applicable). The server may also include in the datagram other data about the matching products, such as data found in the retailer data (311). This data is then transmitted (421) to the client application (321). If no match is found, the server (309) indicates as such to the client application (321) over the network, which then notifies the user (419). The user may then enter alternative search criteria (413) and restart the search process.

If matches are received (421), the client device the uses the map point translation data (319) in the map bundle (315) to determine (423) where on the currently displayed map image (317) to display a location visualization. The application (321) then displays a location visualization (425) at the determined location or locations. The user may then enter different search criteria (413) as described previously to search for other or alternative products, or refine the prior search.

The location visualization (415) is a visual indication on the application (321) graphical user interface of where the searched-for product is located on the map image (317). By way of example and not limitation, the location visualization (425) may be a “pindrop,” which is a graphical image of a pin overlayed on the map such that the point of the pin is at a location on the map image (317), generally corresponding to the location of the product in the store as defined in planogram data (313).

It should be noted that varying levels of map point precision may be available for a particular store. By way of example and not limitation, a map point may be correspond to a specific aisle, a sublocation within an aisle (e.g., one side of the aisle, or a subfixture within a side of an aisle), or a department in the retail location. For example, aisle-level data may be all that is available for certain products, such as seasonal items, in which case the entire seasonal aisle may correspond to a single map point which, as described elsewhere herein, is generally calculated to be the mid-point of the aisle for display and user orientation purposes. Also, for some products, no planogram data (313) is available due to the nature of the product. For example, produce in a grocery store generally has no corresponding planogram data (313). In such cases, a single map point may be determined for the produce department, and in the product location database (601), products with a “produce” category tier are associated with the produce department map point. Thus, a search for any type of produce will yield, a minimum, the produce department as a location for the product. In other circumstances, the absence of data may be considered an indication that the store does not stock the product at all, and appropriate notification is provided to the user device (303).

Because products are organized in the database (601) into a taxonomy and/or category tiers, and because user search criteria may match a given product at different levels of specificity, the search criteria may be used to determine the level of location precision provided. As such, a given product may be associated in the product location database (601) with a plurality of map points, depending upon which layer of the taxonomy matched the user-supplied search criteria.

For example, all carbonated beverages in the product location database (601) may have taxonomical data associating those products with a high-level product category tier for “soda.” Thus, when a user searches for “soda,” all such products match. However, because the user searched for “soda,” rather than a specific brand or packaging configuration of soda, the user likely is trying to locate the soda aisle. Thus, the server may return a map point associated with the entire soda aisle because the search criteria provided was broad, even though more precise map points within the soda aisle are available for specific soda products. However, because the search criteria does not supply sufficient data to determine which specific soda products (and thus, which map point or points) are relevant to the user, aisle-level precision is provided.

By contrast, if the user searches for “coke,” that search criteria also matches a plurality of products, but does not match all soda products. Rather, “coke” matches at a more granular level of the taxonomy (e.g., the brand level). In the product location database (601), all “coke” products may be indicated as stocked on one or more specific subfixtures within the soda aisle. These subfixtures may each have its own independent map points, or may share a map point. When the user searches for “coke,” the system may return to the client application (321) a single shared map point for all “coke” products, or a plurality of individual map points for all matching fixtures. In either case, a generic map point for the soda aisle is not returned, because it can be programmatically determined, based upon the specificity of the request that a more precise location is desired. Again, the categorical precision of the search term is used to determine the location precision of the server response. This is generally done by programmatically examining the level of the taxonomy which matched the search criteria.

This system has the advantage of not only providing product location services at a level of precision corresponding to the typical use case, but reducing the download size of the map bundle (315) and the amount of storage required on the end-user device (303). If the pinpoint location of every product in the store were provided, the map bundle (315) data could become prohibitively large, as it would include location data for tens of thousands of products, when the user likely is only interested in a few dozen. Another advantage of the map point system is that updating the database (601) to account for changes in store layout, such as a reset, is simpler and faster. Rather than having to re-calculate and update the precise pixel location on each map for every product, the map point associated with the product merely changes.

However, for certain products, different location indications may be used. By way of example and not limitation, wine is often densely stocked in grocery stores, and the user is rarely looking for the “wine” aisle, but rather a specific brand or vintner. In such circumstances, it may be desirable to indicate the actual location of the specific product in the aisle. In an embodiment, the software application (321) is programmed to re-create a planogram for a fixture or subfixture. The device (303) can then display the planogram to the user. In an embodiment, a particular product sought may be highlighted or otherwise indicated in the re-created planogram. This may help users to locate a specific product on densely-packed shelves, such as a specific brand of wine, a specific type or brand of spice, or inkjet toner. Alternatively, the client may request a re-created planogram from the server, which will re-create a planogram for a fixture or subfixture, and transmit the re-created planogram to the end-user device (303).

In an embodiment, the user may indicate whether a sought product was in fact found at the location indicated by the system. In this fashion, the system supports crowdsourcing. User-provided data may then be incorporated into the server-side database (601) to flag potentially erroneous records for manual review. Similarly, users may be provided with feedback from prior users seeking the same products. For example, the interface on the end-device (303) application may indicate how many prior users searching for the same products reported that they were able to find the product at the indicated location. This data may help users assess the accuracy of the product location data, and correct user errors, such as going to the wrong aisle or selecting the wrong store.

In certain embodiments, map images (317) may be produced manually using map editing and creating software. This is particularly useful where planogram data is incomplete, inaccurate, or simply unavailable. In such embodiments, the map is created with reference to manually-captured measurements. For example, the actual distances and dimensions of fixtures and locations of products thereon may be manually determined. In effect, planogram data (313) is manually generated for a store and used to generate map images (317). This process is time-consuming, and in an embodiment, may be augmented through the use of hand-held product identification scanners, such as a UPC scanner. Such handheld scanners may also interface with a user device to facilitate quick storage of the scanned information. In an embodiment, this may also be done using the user device (303) application (321), such as by imaging product identification codes using imaging hardware integrated into the user device (303). Additionally, the internal sensors of the user device may be used to detect the device's movement through the retail location, providing at least some automated location detection of products. That is, if a scanning session is begun and the device detects that the user has walked 10 feet, and then a product is scanned, the device can store in memory that the scan was conducted ten feet from the starting point. Likewise, internal device sensors can be used to detect changes in orientation, such as the user turning and changing direction. In an alternative embodiment, a map may be hand-drawn on a device, such as a tablet PC, and edited using map editing software.

In an embodiment, the systems and methods further integrate with inventory management or point of sale data to provide additional information, such as available quantities, prices, and other commercial data about the products. This data may also be included in the product location database (601) for the products, and some or all of this data may be included in the datagram transmitted to the client application (321) in response to a search request, and some or all of such received data may be indicated or displayed to the user.

Retailer data (311) and/or planogram data (313) may occasionally be updated or altered. The updated data (311) and (313) may indicate that some products have been discontinued, added, or restocked in a different location. Such data (311) and (313) may change on a regular schedule, such as a weekly or seasonal update. The updated data (311) and (313) may also indicate relocated or changed fixture locations and/or dimensions, and/or changed shelf placement and/or stocking inventories. The database (601) may be updated to reflect changes in such data (311) and (313). This may be done by identifying changes in the new data (311) and (313) as compared to the existing state of the database (601) and updating products for which location data has changed. However, it some circumstances it may be desirable to simply re-generate the database (601) and/or map bundles (315) from scratch based on the new data (311) and (313).

In an embodiment, the application (321) may use indoor location technologies, whether now known or in the future developed in the art, to determine the location of the user device (303) in the store. Such technologies may include, without limitation, the use of beacons, inertial dead-reckoning, magnetic fingerprinting, Wi-Fi signal fingerprinting, and other Wi-Fi-based location technologies. By way of example and not limitation, one such technology is described in U.S. Utility patent application Ser. No. 13/943,646, filed Jul. 16, 2013, the entirety of which is incorporated herein by reference. In an embodiment supporting indoor location systems, the application (321) may automatically detect available indoor location systems, and/or may query the server for a list of available indoor location systems available at the store. The user may then be provided a graphical user interface by which the user may select which indoor location systems the user wishes to use.

In an embodiment, the application (321) allows the user to search for products without identifying a specific store. In such embodiment, the database (601) or a plurality of databases (601) may be consulted to determine all stores indicated in the database (601) to stock the matching product, and the user may be provided with a list of matching stores near the user based on the user's currently detected location. The user's detected location is generally determined using integrated location technologies in the user device (303), such as a GPS receiver.

In an embodiment, the systems and methods provide user analytics. Such analytics may be developed based upon, among other things, user searches, user locations, and purchasing patterns. By way of example and not limitation, where a user is determined to have searched for a particular product, and sales data indicates a sale of the searched-for product, analytics may be developed concerning the relationship between searched-for products using the systems and methods and user purchasing decisions. Such analytics may be then be used to refine, adjust, or supplement other components of the system, such as but not necessarily limited to: map generation; map point calculations; volume, prices, sales and related variables; and, search and matching algorithms.

While this invention has been disclosed in connection with certain preferred embodiments, this should not be taken as a limitation to all of the provided details. Modifications and variations of the described embodiments may be made without departing from the spirit and scope of this invention, and other embodiments should be understood to be encompassed in the present disclosure as would be understood by those of ordinary skill in the art.

1. A method for displaying a location visualization to a user comprising:
providing a server communicatively coupled to a non-transitory computer-readable server memory and being communicably coupled to a data network;
providing a user device having a user device memory and being communicably coupled to said data network;
receiving retailer data for a retail location, said retailer data comprising product data for a plurality of products offered for sale at said retail location;
receiving planogram data for a retail location, said planogram data comprising:
fixture location data indicative of the relative positions and dimensions of a plurality of fixtures in said retail location;
for each fixture in said plurality of fixtures, an indication of at least one product stocked on said fixture, said at least one product being a product in said plurality of products in said retailer data;
for each fixture in said plurality of fixtures, calculating a map point in said retail location, said calculated map point being determined least in part based upon said relative position of said fixture in said retail location;
for each product in said at least one product stocked on each fixture in said plurality of fixtures, storing in a said non-transitory computer-readable server memory a database record comprising search criteria for said each product and a unique identifier for said calculated map point corresponding to said each fixture;
generating a map image portraying the position of said at least one fixture in said retail location based at least in part on said fixture location data;
for each calculated map point, calculating a pixel location on said map image, said calculated pixel location being a location on said map image corresponding to the location of said each calculated map point in said retail store;
said user device receiving over said network said map image and translation data, said translation data comprising, for each calculated map point, said unique identifier and said calculated pixel location on said map image corresponding to said each calculated map point;
said server receiving from said user device over said network user search criteria;
said server identifying database record(s) having search criteria matching said user search criteria;
for each identified database record, said server sending to said user device over said network said unique identifier in said each identified database record;
for each unique identifier received by said user device, said user device using said received translation data to translate said received unique identifier to said calculated pixel location for said map point;
said user device displaying said map image; and
said user device displaying on said displayed map image, for each translated pixel location, a location visualization at said pixel location.

2. The method of claim 1, wherein said data network is the Internet.

3. The method of claim 1, wherein said user device is a smart phone or tablet coputer.

4. The method of claim 1, wherein said unique identifier is a serial number.

5. The method of claim 1, wherein said search criteria is a text string.

6. The method of claim 1, wherein said search criteria is a product identification code.

7. The method of claim 1, wherein said location visualization is a pindrop.

8. The method of claim 1, where retailer data comprises, for each product, product name, product description, or product category.

9. The method of claim 1, wherein planogram data is received from planogramming software.

10. The method of claim 1, wherein each calculated map point is a relative position in said retail location with respect to a predefined origin point.

11. The method of claim 1, wherein said each relative position for said plurality of fixtures is a relative position in said retail location with respect to a predefined origin point.

12. The method of claim 1, said method further comprising:
said user device determining the location of said user device in said retail location; and
said user device displaying on said displayed map image an indication of the position of said user device in said indoor location.

13. The method of claim 1, wherein each database record for each product further comprises taxonomical data for said each product.

14. The method of claim 1, wherein for each database record for each product, said search criteria comprises a synonym for said each product, phonetic data for said each product, or slang for said each product.

15. The method of claim 1, said location visualization further comprises user interface elements for a user to indicate whether the user found the desired product at the location in the store indicated by the location visualization.
